(19) United States
(12) Patent Application Publication
(10) Pub. No.: US 2007/0241914 A1
(43) Pub. Date: Oct. 18, 2007

(54) Vehicular awakening information output apparatus

(76) Inventors: Toru Ihara, Kawasaki (JP); Keiichi Yamamoto, Kawasaki (JP)

Correspondence Address: JACOBSON HOLMAN PLLC, 400 SEVENTH STREET N.W., SUITE 600, WASHINGTON, DC, 20004, US

(21) Appl. No.: 11/727,881

(22) Filed: Mar. 28, 2007

(30) Foreign Application Priority Data
Mar. 28, 2006 (JP) 2006-087081

(51) Int. Cl. G08B 23/00

(52) U.S. Cl. 340/575

(57) ABSTRACT

Awakening degree calculating means calculates an awakening degree at intervals of 15 seconds for example that is shorter than a shortest period of changes of awakening level, and output control means updates and outputs a display output and an alarm sound output based on the awakening degree in accordance to an output condition logic set in advance. When the awakening degree drops less than a predetermined threshold value, the output control means updates the display output of the awakening degree at first time intervals in calculating the awakening degree and outputs the alarm sound output corresponding to a worsened level of the awakening degree. When the awakening degree is not lower than the predetermined threshold value or when the awakening degree recovers by exceeding the predetermined threshold value, the output control means updates the display output at second time intervals that are longer than the first time intervals.

### BACKGROUND OF THE INVENTION

1. Field of the Invention

The present invention relates to a vehicular awakening information output apparatus for providing information on a power of attention or of a degree of awakening (called as an awakening degree hereinafter) of a driver of a vehicle to the driver to provoke the attention to driving.

2. Description of the Related Art

There has been disclosed an apparatus that estimates an awakening degree of a driver based on drive control states such as a meandering rate, controls of an exhaust brake, controls of a gear shift, displays the estimated awakening degree and alarms the driver when the awakening degree drops.

The apparatus described above calculates the awakening degree at predetermined time intervals (e.g., per minute), displays a predetermined number of nearest awakening degrees (e.g., ten) on a graph representing the awakening degree by an axis of ordinate and time by an axis of abscissa and alarms when the awakening degree drops less than a threshold value.

However, although the apparatus calculates and outputs the awakening degree at intervals of one minute, a research has been reported that a period of changes of awakening level is about 25 seconds to 251 seconds. Then, according to this report, the awakening level may drop within an interval shorter than one minute. Therefore, there is a case when the alarm becomes late when the awakening degree drops suddenly within 25 seconds for example. When the interval for calculating and outputting the awakening degree is shortened on the other hand to solve this problem, information amount of the calculation increases, so that it becomes necessary to reduce an information amount to be displayed on one display screen or to display the information minutely, worsening user interface. Furthermore, if the interval for calculating and outputting the awakening degree is shortened, there is a case when an output is updated to a recovered awakening degree even when the awakening degree of the driver who has been alarmed is merely improved only for a short time (momentarily). Then, as a result, the driver may feel easy and the awakening degree may drop again.

In view of such problems, the present invention provides a vehicular awakening information output apparatus capable of effectively provoking a power of attention of the driver by outputting the awakening degree at adequate timing without worsening the user interface.

### SUMMARY OF THE INVENTION

In order to solve the aforementioned problems, a vehicular awakening information output apparatus includes awakening degree calculating means for calculating an awakening degree of a driver of a vehicle at first time intervals and awakening degree output means for outputting information on the awakening degree calculated by the awakening degree calculating means; wherein the awakening degree output means includes normal output means for updating and outputting the information on awakening degree at second time interval which is longer than the first time interval and output means-when-awakening degree drops for updating and outputting the information on awakening degree when the awakening degree calculated by the awakening degree calculating means becomes lower than a predetermined value before the second time interval elapses since when the information on awakening degree has been outputted by the normal output means.

According to this vehicular awakening information output apparatus, while the awakening degree calculating means calculates the awakening degree of the driver at the first time intervals, the awakening degree output means outputs the information of the awakening degree by the output means-when-awakening degree drops when the calculated awakening degree becomes lower than the predetermined value and in cases other than that, outputs the information of the awakening degree at the second time interval that is longer than the first time interval by the normal output means.

Because the present invention allows the information on awakening degree to be updated and outputted at the adequate time intervals and the information on the awakening degree to be updated and outputted at the time interval shorter than the normal time interval in updating and outputting the information when the awakening degree drops, it becomes possible to effectively provoke the power of attention of the driver.

### BRIEF DESCRIPTION OF THE DRAWINGS

FIG. 1 is a block diagram showing a system configuration of a vehicular awakening information output apparatus according to an embodiment of the present invention;

FIG. 2 is a diagram showing a functional configuration of the vehicular awakening information output apparatus;

FIG. 3 is a block diagram explaining an awakening degree calculating method;

FIG. 4 is a chart for explaining timings for calculating the awakening degrees;

FIG. 5 is a table showing logics of output conditions; and

FIGS. 6A and 6B are graphs for comparing a conventional method with a present inventive method on transition of awakening degree and update of outputs.

### DESCRIPTION OF THE PREFERRED EMBODIMENTS

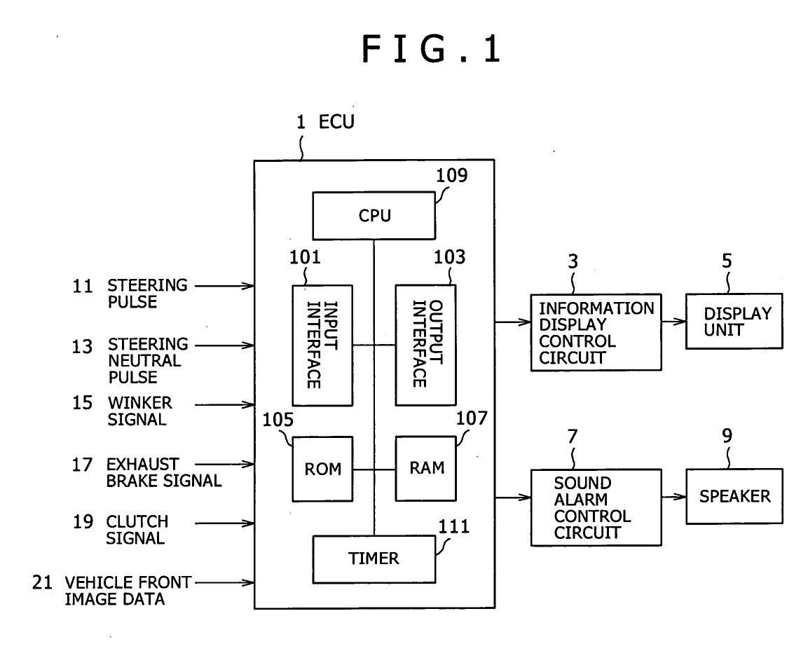

A preferred embodiment of the invention will be explained in detail based on the drawings. FIG. 1 is a block diagram showing a system configuration of a vehicular awakening information output apparatus according to an embodiment of the present invention.

The vehicular awakening information output apparatus of the embodiment includes an electronic control unit (ECU) 1, an information display control circuit 3, a display unit 5, a sound alarm control circuit 7 and a speaker 9.

The ECU 1 receives information such as a steering pulse 11, a steering neutral pulse 13, a winker signal 15 an exhaust brake signal 17, a clutch signal 19, a vehicle front image data 21 and others and calculates an awakening degree of a driver based on the information on those drive controls and vehicular behaviors.

The ECU 1 is composed of a CPU (central processing unit) 109, memories such as a ROM (read only memory) 105 for storing program instructions and data and a RAM (random access memory) 107, an input interface 101 for taking the respective inputs described above to the ECU 1, an output interface 103 for outputting information such as the awakening degree calculated within the ECU 1, a timer 111 and others.

Then, the ECU 1 presents the driver of information on the calculated awakening degree by displaying on the display unit 5 via the information display control circuit 3 and outputs voice alarm messages (alarm sound) corresponding to levels of the calculated awakening degree out of the speaker 9 (alarm means) by driving the sound alarm control circuit 7.

The display unit 5 is a color liquid crystal display built into an instrument panel that is installed in front of a driver's seat of the vehicle for example. The speaker 9 is also built in a ceiling of the driver's seat for example.

Various signal sensors built in the vehicle detect and send the various signals 11, 13, 15, 17, 19 and 21 to the ECU 1.

For example, the winker signal 15, the exhaust brake signal 17 and the clutch signal 19 are detected by switches or the like built in a winker, an exhaust brake and a clutch pedal that are vehicle control means. The steering pulse 11 and the steering neutral pulse 13 are information on steering operations and are detected by a steering angle sensor built in a steering handle mechanism.

The vehicle front image data 21 is image data of a front side of the vehicle taken by a camera attached to an upper part of a front glass for example. The ECU 1 identifies a white line of a road from this image data, detects position of the vehicle within a lane and calculates information on a drift of the vehicle.

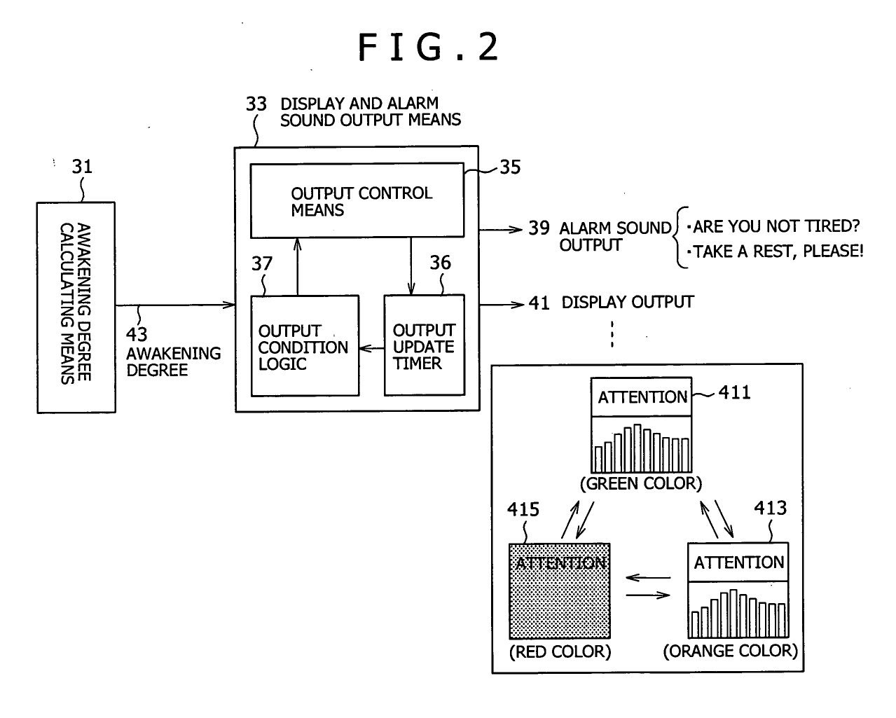

FIG. 2 is a diagram of a functional configuration of the ECU 1.

The ECU 1 is composed of awakening degree calculating means 31 for calculating an awakening degree 43 from the information on the drive control states such as the steering pulse 11, the steering neutral pulse 13, the winker signal 15, the exhaust brake signal 17, the clutch signal 19 and the vehicle front image data 21 and display and alarm sound output means 33 (awakening degree output means) for outputting an alarm sound output 39 and a display output 41 based on the awakening degree 43 calculated by the awakening degree calculating means 31.

The display and alarm sound output means 33 includes output control means 35 that determines output contents by making reference to output condition logic 37 set in advance for the awakening degree 43 and an output update timer 36. The output condition logic 37 is stored in the ROM 105 within the ECU 1.

The display output 41 is graphed as history information showing elapsed changes of awakening degree up to the present time and is shown as a bar graph for example as shown in FIG. 2. The bar graph shows awakening degrees of 10 elements (at 10 points of time) in FIG. 2. This bar graph represents the awakening degrees by heights of bars of 10 steps and arranges the awakening degrees at respective times in order from old one.

The display is updated normally per minute as described later and when the awakening degree worsens less than a predetermined value, it is updated in unit of 15 seconds (first time intervals) and values of awakening degrees at 10 points of time are represented by the bar graph. Accordingly, the driver can visually confirm the transition of the awakening degrees of 10 minutes in maximum from the changes of height of the bars displayed in the graph.

In updating the output, the awakening degrees at 10 points of time which have been displayed are stored in the RAM 107 of the ECU 1. Then, the awakening degrees at 9 points of time, except the oldest one, stored in the RAM 107 are read in updating the output and are displayed together with a newest awakening degree. The awakening degrees at 10 points of time including the newest awakening degree are stored again to the RAM 107 of the ECU 1.

The output update timer 36 counts time from the previous update of the display and the output control means 35 resets the counted value every time when the display output 41 is displayed and updated. The output control means 35 normally updates the display when one minute (second time interval) elapses from the previous update of the display. When the awakening degree worsens and drops less than a predetermined value set in the output condition logic 37 on the other hand, it updates the display when 15 seconds, 30 seconds or 45 seconds elapses from the previous update of the display. In concrete, it changes display colors of the display output 41 or outputs the alarm sound output 39, depending on a worsened level of the awakening degree.

The display output 41 provokes attention of the driver also by the display color as shown in FIG. 2. The display output 41 represents it in green color 411 when the awakening degree (level of power of attention) is high for example, in orange color 413 when the awakening degree drops within a predetermined range and in red color 415 when the awakening degree drops considerably.

The alarm sound output 39 provokes the power of attention by voice or the like corresponding to the drop of levels of the awakening degree. It calls the driver's attention by an alarm voice such as “Are you not tired?” for example when the awakening degree drops to the level of the orange display 413 in the display output 41. It also outputs an alarming voice such as “Take a rest, please!” when the awakening degree drops considerably to the level of the red display 415 in the display output 41.

It is also possible to use electronic sounds such as buzzer, beside the voice alarm as described above.

The output control means 35 outputs the display output 41 and the alarm sound output 39 described above in accordance to the output condition logic 37 and the output update timer 36 by judging the level and changes of the awakening degree 43 per every 15 seconds. The output condition logic 37 and the output update timer 36 will be detailed later.

Next, a method for calculating the awakening degree 43 by means of the awakening degree calculating means 31 will be explained.

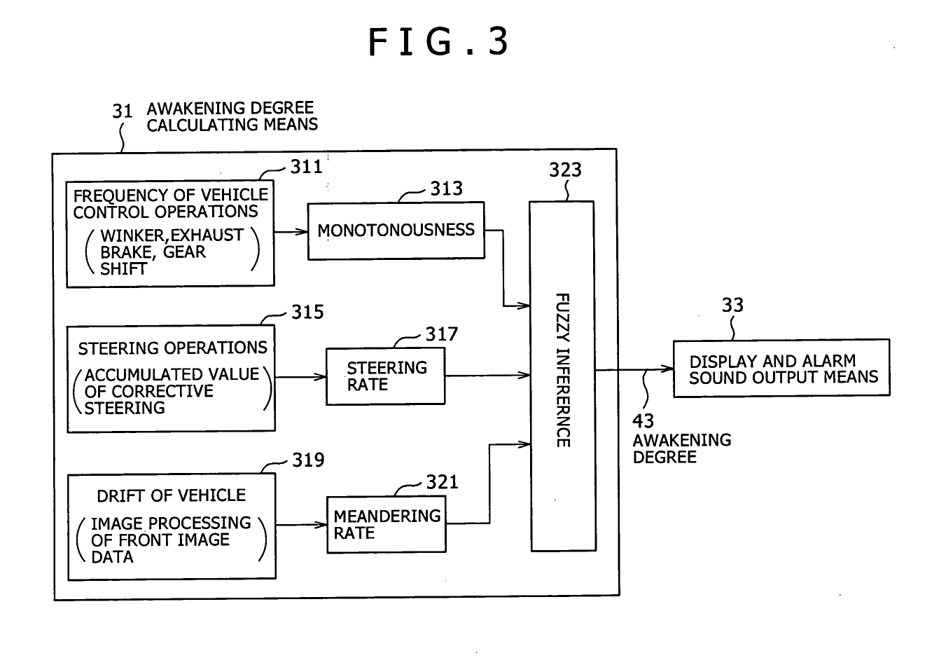

FIG. 3 is a block diagram explaining an outline for calculating the awakening degree.

That is, monotonousness 313 of drive control is found from a frequency of vehicle control operations 311 such as control of the winkers (the winker signal 15), control of the exhaust brake (the exhaust brake signal 17), control of the gear shift (the clutch signal 19) and the like, except the steering operations of the vehicle.

Meantime, as for steering operations 315, an integrated value of corrective steering with respect to an advancing direction of the vehicle is found as a steering rate 317 from the steering pulse 11 and the steering neutral pulse 13.

Furthermore, a drift 319 of the vehicle is found from changes of information on a white line on a road that is found by processing recognition of the vehicle front image data 21 taken by a camera mounted on the vehicle to find a meandering rate 321 of the vehicle to the road (lane specified by the white line).

The awakening degree 43 of the driver is calculated by a fuzzy inference processing 323 from the monotonousness 313, the steering rate 317 and the meandering rate 321 found as described above and based on predetermined membership functions and the display and alarm sound output means 33 described above carries out the display and alarm of the awakening degree.

A processing procedure for calculating the awakening degree by means of the fuzzy inference is stored in the ROM 105 of the ECU 1 as a program and the CPU 109 executes it to calculate the awakening degree 43.

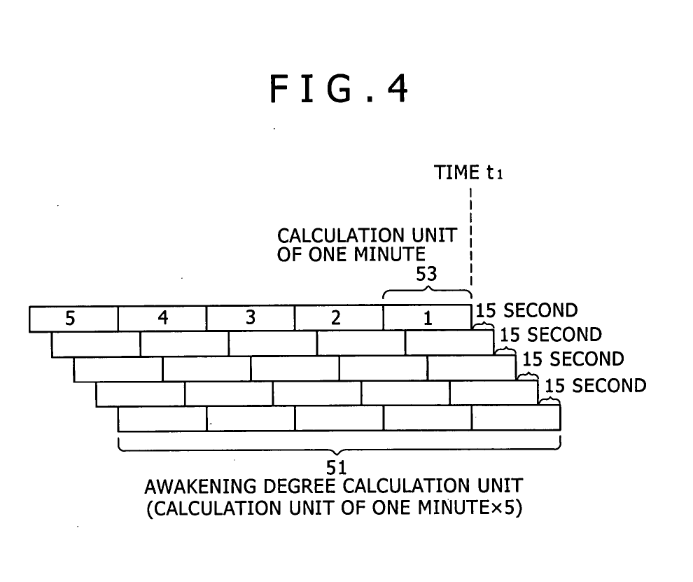

FIG. 4 is a chart showing timings of calculating the awakening degrees by the awakening degree calculating means 31. The timer 111 within the ECU 1 measures time.

At first, the awakening degree calculating means 31 calculates the awakening degree 43 at a point of time of time t₁. At this time, the awakening degree calculating means 31 sets newest data within one minute of the monotonousness 313, the steering rate 317 and the meandering rate 321 as one minute calculating unit 53 and calculates the awakening degree 43 from average data of past five minutes and by the fuzzy inference 323. That is, the awakening degree 43 is calculated based on the data of five minutes (third time interval) of an awakening degree calculating unit 51.

Next, when 15 seconds elapses time t₁, the awakening degree calculating means 31 finds the awakening degree 43 at time (t₁+15) from average data of the monotonousness 313, the steering rate 317 and the meandering rate 321 of past five minutes. The awakening degree calculating means 31 finds the awakening degree 43 from data of past five minutes on and after that.

Thus the awakening degree 43 is calculated by the awakening degree calculating means 31 per every 15 seconds and is inputted to the display and alarm sound output means 33.

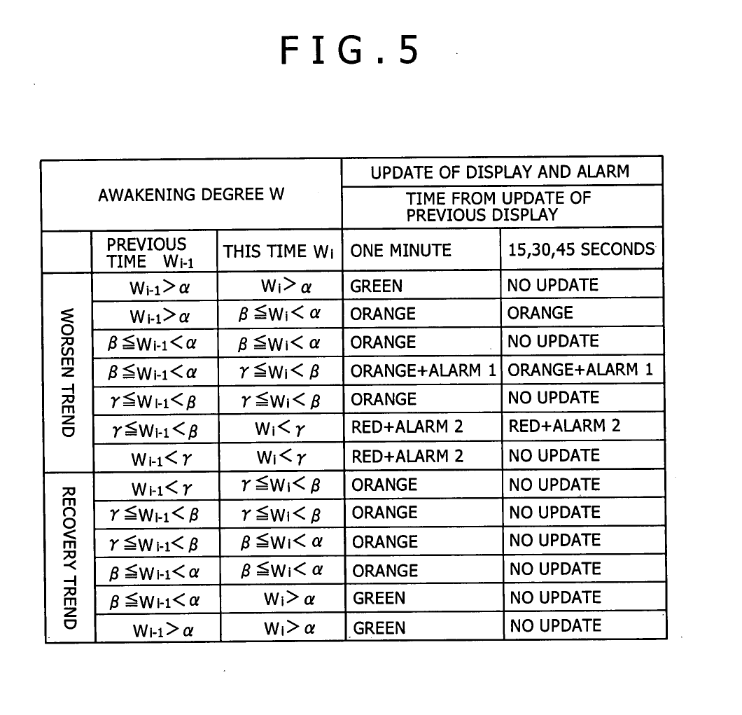

FIG. 5 is a table showing the output condition logic 37 of the display and alarm sound output means 33.

Based on the awakening degree 43 inputted per every 15 seconds, the output control means 35 controls outputs of the display output 41 and the alarm sound output 39 by making reference to the output condition logic 37 in FIG. 5 and the output update timer 36.

It is supposed that the green display 411 is outputted when the awakening degree 43 (level of power of attention) is fully high, the orange display 413 is outputted when the awakening degree 43 drops within a predetermined range and the red display 415 is outputted when the awakening degree 43 drops considerably, as shown in FIG. 2. The alarm sound output 39 is also outputted along that.

Then, threshold values α, β and γ are set for the awakening degree 43. When the awakening degree 43 is W here, w>α is considered to be a normal level in which the awakening degree (level of power of attention) is fully high, β≦W<α to be a level in which the awakening degree drops by a certain degree, γ≦W<β to be a level in which the awakening degree drops further and W<γ to be a level in which the awakening degree drops considerably.

The threshold values α, β and γ are set as predetermined values in advance and are stored in the ROM 105 within the ECU 1. The output condition logic 37 shown in FIG. 5 is also stored in the ROM 105 of the ECU 1.

The awakening degree W (43) is calculated by the awakening degree calculating means 31 per every 15 seconds and is inputted to the display and alarm sound output means 33. Here, a value of the awakening degree 43 inputted this time will be referred to as W₁ and a value of the awakening degree 43 inputted previously by 15 seconds as Wᵢ₋₁. The previous awakening degree Wᵢ₋₁ is stored in the RAM 107 within the ECU 1.

The output control means 35 determines a method for outputting the display output 41 and the alarm sound output 39 from the awakening degree Wᵢ of this time inputted from the awakening degree calculating means 31, the value of the awakening degree Wᵢ₋₁ of 15 seconds before and time (15 seconds, 30 seconds, 45 seconds and one minute) from the previous update of the display counted by the output update timer 36, and based on the output condition logic 37 shown in FIG. 5.

That is, when the awakening degrees of the previous time (15 seconds before) and this time are both fair (Wᵢ₋₁>α and W₁>α), the display is updated when the time since the previous update passes one minute. That is, the bars of the green display 411 are shifted to left one by one and a bar graph element of the value of awakening degree W₁ of this time is represented on a right end of the graph. The display is not updated and the previously displayed green display 411 is continued when the elapsed time is only 15 seconds, 30 seconds or 45 seconds since the previous update.

When the awakening degree was fair in the previous time (15 seconds before) and it becomes less than the threshold value α this time (Wᵢ₋₁>α and β≦W₁<α), the display is updated immediately regardless of the time since the previous update. That is, the bars in the green display 411 previously displayed are shifted to the left one by one, a bar graph element of the awakening degree value W₁ of this time is added to the right end and the display color is changed to orange.

The display is then updated at time intervals shorter than one minute that is the normal time interval for updating the display and the display color is changed, so that the driver may recognize the drop of the awakening degree relatively quickly and may pay attention.

When the awakening degree that has slightly dropped is kept on the same level (β≦Wᵢ₋₁<α and β≦W₁<α), the display is updated only when the time since the previous update is one minute, the bar graph in the orange display 413 is updated and a bar graph element of the awakening degree W₁ of this time is added to the right end. The orange display 413 is continued when the time is other time of 15 seconds, 30 seconds or 45 seconds.

When the awakening degree worsens further and becomes lower than the threshold value β (β≦Wᵢ₋₁<α and γ≦Wᵢ<β), the display is updated immediately regardless of the time since the previous update. That is, the bar graph in the orange display 413 is updated, a bar graph element of the awakening degree wᵢ of this time is added to the right end of the graph and the alarm sound 1 is outputted as the alarm sound output 39. Alarming voices such as “Are you not tired?” and “Is your power of attention OK?” for example are outputted from the speaker 9.

Thereby, the driver can immediately recognize the drop of the power of attention.

Next, when the awakening degree is kept on this level (γ≦Wᵢ₋₁<β and γ≦Wᵢ<β), the display is updated only when the time since the previous update is one minute, the bar graph in the orange display 413 is updated and a bar graph element of the awakening degree wᵢ of this time is added to the right end. The orange display 413 is continued when the time is other time of 15 seconds, 30 seconds or 45 seconds. The alarm sound 1 may not be outputted when the awakening degrees of the previous time and this time are on the same level.

When the awakening degree worsens further and becomes less than the threshold value γ(γ≦Wᵢ₋₁<β and Wᵢ<γ), the display is updated immediately regardless of the time since the previous update. That is, the display color is changed to red and an alarm sound 2 is outputted.

At this time, a display that may largely provoke the power of attention may be made to largely provoke the power of attention, instead of representing the awakening degree by the bar graph as shown in FIG. 2.

“Your power of attention has dropped. Take a rest, please” and the like for example may be outputted out of the speaker 9 as the alarm sound 2.

When the awakening degree is kept in the worsened state (Wᵢ₋₁<γ and Wᵢ<γ), the display is updated only when the time since the previous update is one minute and the alarm sound 2 is outputted again. The display is not updated when the time is the other time of 15 seconds, 30 seconds or 45 seconds and the previous red display 415 is continued.

Although the output condition logic 37 described above is what the awakening degree is in a worse trend, there is also a case when the awakening degree improves from each state of the awakening degree. The output condition logic 37 when the awakening degree is in a recovery trend will be explained below.

When the awakening degree is in the recovery trend, the display is not updated unless the time elapses one minute since the previous update even if the awakening degree recovers from any state.

That is, when the awakening degree at the time when the display is previously updated is Wᵢ₋₁<γ and the awakening degree of this time after 15 seconds is improved to be γ≦Wᵢ<β, the display is not updated and the red display 415 up to then is continued.

The display is not updated after next 15 seconds, i.e., even when the awakening degree after 30 seconds since the previous update is γ≦Wᵢ≦β(γ≦Wᵢ₋₁<β at this time) and the red display 415 is continued because the elapsed time since the previous update is not one minute. The display is not also updated after next 15 seconds, i.e., when the awakening degree after 45 seconds since the previous update is γ≦Wᵢ<β(γ≦Wᵢ₋₁<β at this time)

The display is updated for the first time after next 15 seconds, i.e., when the awakening degree after one minute since the previous update becomes γ≦Wᵢ<β(γ≦Wᵢ₋₁<β at this time). The display color is changed from red to orange and the newest awakening degree wᵢ is displayed on the bar graph together with the awakening degree values at the past nine points of time stored in the RAM 107 within the ECU 1.

The alarm sound is not outputted when the awakening degree is in the trend of improvement.

When the awakening degree is in the trend of improvement or is equal, the display is updated only when the elapsed time since the previous update is one minute, the display is not updated when the elapsed time is 15 seconds, 30 seconds or 45 seconds and the display is continued in the same manner.

From the output condition logic 37 described above, the output control means 35 can provoke the power of attention of the driver by updating the display and outputting the alarm sounds immediately, i.e., at the same time intervals with that of the calculation of the awakening degree, when the awakening degree drops by exceeding the predetermined value.

There is also a case when the driver recovers his/her power of attention momentarily for a short time due to the alarm or the like. If the display of the power of attention is updated to the safe side due to such recovery of short time, the driver may feel easy, lowering the power of attention again and increasing a danger in contrary. However, it is possible to avoid such danger by updating the display at intervals of one minute, which is longer than the time interval (15 seconds) in calculating the awakening degree when the awakening degree is being improved.

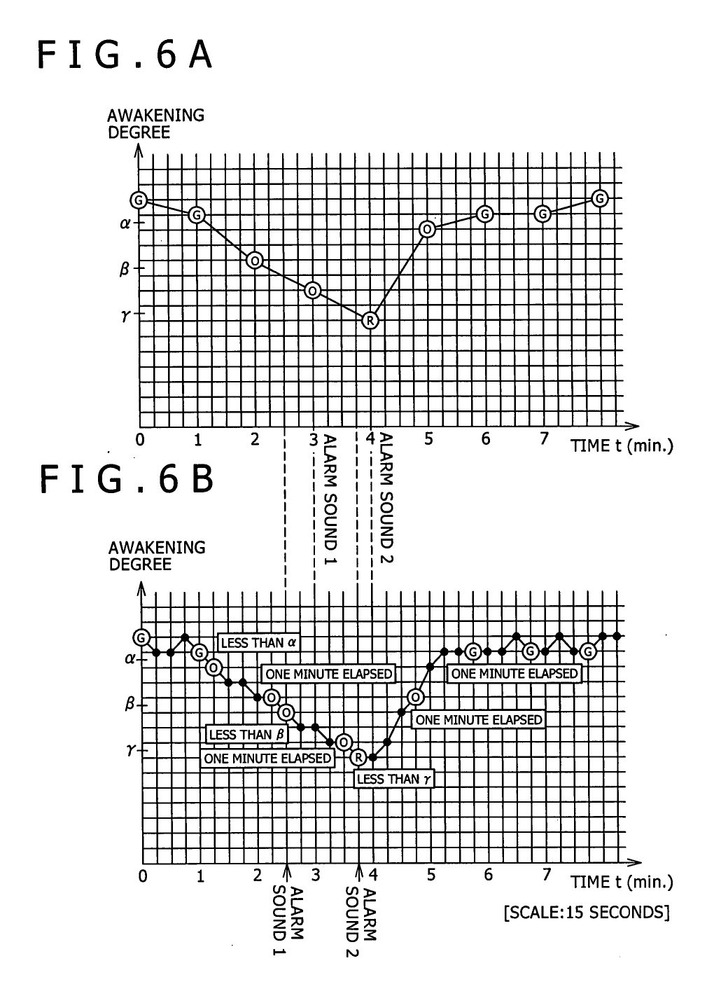

FIGS. 6A and 6B are comparative graphs of update timings exemplifying transitions of calculated values of awakening degrees in calculating the awakening degrees and updating the outputs per minute according to the conventional method (FIG. 6A) and in calculating the awakening degrees per 15 seconds and updating the output in accordance to the output condition logic 37 of the present invention (FIG. 6B). It is noted that the awakening degree calculation algorithm is the same for the both, except of their calculation time intervals. Within the tables, their axis of ordinate represents calculated values of awakening degree and axis of abscissa represents elapsed times.

In the conventional case (FIG. 6A), the output is updated per minute by the value of awakening degree calculated per minute. That is, while the awakening degree is larger than α at time t=0 and the display is made in green color (G), the display is updated in the same manner also at time t=1 after one minute and is display is made in green color (G). Then, at time t=2 after one minute, the awakening degree becomes lower than the threshold value α and the display color is changed to orange color (O) when this display is updated. At time t=3 after another one minute, the awakening degree becomes lower than the threshold value β and the alarm sound 1 is outputted when the display is updated. The display color remains to be orange color (O) at this time.

At time t=4, the awakening degree becomes lower than the threshold value γ, the display color is changed to red (R) when the display is updated and the alarm sound 2 is outputted. The power of attention of the driver is improved by this red display and the alarm sound 2, and the display is updated per minute.

When the vehicular awakening information output apparatus of the invention is used on the other hand (FIG. 6B), it is possible to update the output more swiftly when the awakening degree is worsened because the awakening degree is calculated per 15 seconds, which is shorter than the time interval (one minute) in normally updating the display.

In FIG. 6B, the transition of the awakening degrees per 15 seconds is represented by a broken line and display colors (green G, orange O and red R) are shown on points of the broken line when the update of output is made.

As shown in the figure, the awakening degree up to time t=1 is on a normal level where the awakening degree is greater than the threshold value α, and it becomes lower than the threshold value α at time t=one minute and 15 seconds. Because the display is updated by changing the display color to orange (O) at this point of time in the inventive method, the alarm is outputted quickly in the example shown in the figure as compared to the conventional method by 45 seconds.

The awakening degree is on the same level until one minute passes (β<awakening degree W<α) and the display is not updated until a point of time of t=2 minutes and 15 seconds after one minute at this time. When the awakening degree W becomes lower than the threshold value β after 15 seconds, i.e., at time t=2 minutes and 30 seconds, the display is updated immediately and the alarm 1 is outputted even though the elapsed time since the previous update is 15 seconds.

The alarm 1 to be outputted when the awakening degree becomes lower than the threshold value β is outputted quickly as compared to the conventional case by 30 seconds and it becomes possible to quickly provoke the power of attention of the driver.

The awakening degree is on the same level until one minute passes (γ<awakening degree W<β) and the display is not updated till a point of time of t=3 minutes and 30 seconds after one minute at this time. When the awakening degree W becomes lower than the threshold value γ after 15 seconds, i.e., at time t=3 minutes and 45 seconds, the display is updated immediately and the alarm 2 is also outputted even though the elapsed time since the previous update is 15 seconds. This is carried out quickly as compared to the conventional case by 15 seconds.

After that, although the awakening degree is in the trend of recovery and the awakening degree becomes greater than the threshold value γ at a point of time t=4 minutes and 15 seconds after 30 seconds when the display has been previously updated and the alarm sound 2 has been outputted, the display is not immediately at the time of recovery. That is, the display is updated by changing the display color to orange that indicates the recovery trend for the first time at a point of time t=4 minutes and 45 seconds after one minute. The driver can keep the tension by continuing the red display during this time.

Although the awakening degree is calculated per 15 seconds and is judged by the output condition logic 37 on and after that, the display is updated only per minute at the time when the awakening degree is in the recovery trend.

As it is apparent from the figure, the vehicular awakening information output apparatus of the invention updates the display and outputs the alarms at the time intervals of calculation of awakening degrees when the awakening degree becomes worse exceeding the predetermined threshold values and updates the display at the time intervals which is longer than the time intervals in calculating the awakening degrees when the awakening degree recovers by exceeding the threshold values or when the awakening degree does not exceed the threshold values, so that the vehicular awakening information output apparatus can update the display and output the alarm sounds at appropriate timing without loosing a sudden drop of the awakening degree of the driver while following the same user interface with the past.

It is noted that the invention is not limited to the embodiment described above and may be modified variously within the technological range of the invention. For example, although the interval for calculating the awakening degree has been 15 seconds in the description of the embodiment, the interval is not limited to that. However, it is preferable to be a time interval that is shorter than the shortest period the changes of awakening level.

The average value of 5 minutes has been also used in the calculation of the awakening degree in the embodiment, this numerical value is not also limited to this number and may be modified. Furthermore, although the history of the past awakening degrees to be displayed are 10 points of time, this may be increased/decreased adequately within a range of not remarkably worsening the user interface by display definition of the display unit.

What is claimed is:

1. A vehicular awakening degree information output apparatus comprising:
awakening degree calculating means for calculating an awakening degree of a driver of a vehicle at first time intervals; and
awakening degree output means for outputting information on the awakening degree calculated by said awakening degree calculating means; wherein said awakening degree output means comprises normal
output means for updating and outputting said information on awakening degree at second time intervals which are longer than said first time intervals; and
output means-when-awakening degree drops for updating and outputting said information on awakening degree when said awakening degree calculated by said awakening degree calculating means becomes lower than a predetermined value before said second time intervals elapses since when said information on awakening degree has been outputted by said normal output means.

2. The vehicular awakening degree information output apparatus according to claim 1, wherein said awakening degree output means updates and outputs said information on awakening degree at said second time intervals by said normal output means when said awakening degree calculating means calculates said awakening degree improved from said predetermined value before said second time intervals elapses after when said awakening degree lower than said predetermined value has been calculated by said awakening degree calculating means.

3. The vehicular awakening degree information output apparatus according to claim 1, wherein said awakening degree output means comprises a display unit whose display color changes corresponding to levels of awakening degree and an alarm means for outputting alarm sounds when said awakening degree becomes lower than predetermined values.

4. The vehicular awakening degree information output apparatus according to claim 1, wherein said awakening degree calculating means calculates an awakening degree of the driver based on states of drive control of the vehicle made by said driver.

5. The vehicular awakening degree information output apparatus according to claim 4, said awakening degree calculating means calculates said awakening degree based on states of drive control of said driver at third time intervals which are longer than said second time intervals.

6. The vehicular awakening degree information output apparatus according to claim 1, wherein said first time intervals are time intervals shorter than a shortest period of changes of awakening level falling into a complete dozing state.

7. The vehicular awakening degree information output apparatus according to claim 1, wherein said third time intervals are time intervals longer than a longest period of changes of awakening level falling into the dozing state.
